(19) United States
(12) Patent Application Publication
(10) Pub. No.: US 2024/0291983 A1
(43) Pub. Date: Aug. 29, 2024

(54) Smart Chunking for Video Encoding

(71) Applicant: Bitmovin GmbH, Klagenfurt am Wörthersee (AT)

(72) Inventors: Radu Ruse, Klagenfurt am Wörthersee (AT); Philipp Schwellenbach, Klagenfurt am Wörthersee (AT); Christian Feldmann, Klagenfurt am Wörthersee (AT); Maxime Rigaud, Klagenfurt am Wörthersee (AT); Alexander Kainz, Klagenfurt am Wörthersee (AT); Carlos Bentzen, Klagenfurt am Wörthersee (AT)

(73) Assignee: Bitmovin GmbH, Klagenfurt am Wörthersee (AT)

(21) Appl. No.: 18/585,379

(22) Filed: Feb. 23, 2024

Related U.S. Application Data
(60) Provisional application No. 63/487,003, filed on Feb. 26, 2023.

(51) Int. Cl. H04N 19/119; H04N 19/146; H04N 19/162

(52) U.S. Cl. CPC H04N 19/119; H04N 19/146; H04N 19/162

(57) ABSTRACT

Techniques for video encoding are described herein. A method for video encoding with smart chunking includes receiving, by a distributed video encoding system, a video input and a target bitrate, the video input having segments of a segment duration, determining an internal chunk length that is a multiple of the segment duration, encoding chunks having the internal chunk length, wherein the average bitrate across the chunk is equal to the target bitrate, and segmenting the encoded chunks into encoded segments of the segment duration. The distributed video encoding system may include various video encoders, or encoder instances, able to encode multiple chunks in parallel. The encoded segments may be output to a client, all of the encoded segments being of equal or similar quality.

### CROSS-REFERENCE TO RELATED APPLICATIONS

This application claims priority to U.S. Patent Application No. 63/487,003 entitled “Smart Chunking for Video Encoding,” filed Feb. 26, 2023, the contents of which are hereby incorporated by reference in their entirety.

### BACKGROUND OF INVENTION

Video compression is an optimization problem with three variables: quality, computational cost, and bitrate. Typically, two of the three variables may be achieved, while sacrificing the third (e.g., good quality and low bitrate with high cost, good quality and low cost with high bitrate, low bitrate and low cost with poor quality), or all three variables may be compromised (i.e., average quality, average bitrate, average cost). FIGS. 2A-C are simplified flow diagrams illustrating typical segment encoding with prior art video encoders. In basic video encoder flow 200, as shown in FIG. 2A, input video 202 is ingested by video encoding system 206 (e.g., in a client system), often with a target bitrate 204, the input video having a given duration (i.e., a given number of hours and/or minutes) and a given content (e.g., a movie, vlog, show episode, etc.). An encoded output video comprising output video segments 208a-n will be of a given quality, subjectively perceived by a viewer and measurable by tools like peak signal-to-noise ratio (“PSNR”), video multimethod assessment fusion (“VMAF”). The encoding process performed by video encoding system 206 has a computational cost that translates to financial costs. The output video is typically segmented (i.e., divided into fragments), for example into output video segments 208a-n, in order to enable streaming to a viewer's device over the internet. Output video segments 208a-n will typically be a few seconds long, resulting in many output video segments 208a-n for an input video 202 that is of typical length (i.e., duration) for many types of content (e.g., movie, vlog, show episodes, etc.). Encoding such a high number of segments creates computational inefficiencies in encoding.

Distributed video encoding systems have been developed to deal with the large number of files from segmentation of video content for encoding, thereby splitting the video encoding computation work across multiple parallel machines. For example, in FIG. 2B, prior art distributed video encoder flow 210 comprises distributed video encoding system 216 configured to receive input video 212 and target bitrate 214. Video encoding system 216 distributes the computational work of video encoding to a plurality of video encoders 216a-m (e.g., computational machines) and outputs output segments 218a-n. As shown in more detail in FIG. 2C, input video 212 is split into n chunks (i.e., chunks 230a-n), which in turn are divided among m video encoders (i.e., video encoders 216a-m) for encoding, thereby reducing encoding time E to

$$( \frac{E}{n} ) * m .$$

In so doing, the turnaround time of the encoding process can be reduced. Usually the chunks are the same duration as the desired output segment duration. However, due to the rate-control algorithm in current video encoders, the quality often decreases at the end of chunks compared to chunk beginnings. Setting the encoder in a variable bitrate (VBR) mode will impact video quality at the end of output video segments, since they typically map to the encoding chunks. For example, as shown in FIG. 3A, quality drops with each 4 second segment.

Furthermore, the desired target bitrate will be applied to all chunks, meaning chunks with high complexity and low complexity videos will have the same target bitrate. This leads to poorer quality for high complexity video chunks and a waste of quality for low complexity video chunks, resulting in overall inefficiency in bitrate usage and an average output bitrate that is typically lower than the customer selected bitrate (e.g., desired target bitrate). For example, as shown in FIG. 4A, the quality of very high complexity segment 402a, very low complexity segment 402b, low complexity segment 402c, and medium complexity segment 402d are all encoded at 8 Mbps, which results in very poor quality output 404a, good quality outputs 404b-c, but with wasted bitrate (e.g., same as if encoding was performed with 4 Mbps or 6 Mbps encoding), and finally relatively poor quality output 404d.

Conventional chunking for encoding further creates inefficiencies due to overhead such as downloading, demuxing, decoding, applying filters, muxings, uploads besides the main encoding operation, among other tasks. Longer chunks are preferable for longer encodings (e.g., encodings of longer input videos) to reduce the overhead and increase distribution, and shorter chunks are preferable for shorter encodings (e.g., encodings of shorter input videos) to increase parallelization as much as possible. Having chunk size strictly connected to output segment thereby results in sub-optimal utilization of the cluster with chunks being equal in duration to output segment duration regardless of input video duration.

Therefore, smart chunking for video encoding is desirable to overcome these limitations of conventional video encoding.

### BRIEF SUMMARY

The present disclosure provides for techniques relating to smart chunking for video encoding. A method for video encoding with smart chunking, may include: receiving, by a distributed video encoding system, a video input and a target bitrate, the video input comprising a plurality of segments, each segment having a segment duration; determining an internal chunk length, the internal chunk length being a multiple of the segment duration; encoding, by the distributed video encoding system, a chunk having the internal chunk length, the distributed video encoding system comprising a plurality of video encoders configured to encode a plurality of chunks in parallel, an average bitrate for encoding the chunk being equal to the target bitrate; segmenting an encoded chunk into two or more encoded segments, each of the two or more encoded segments having the segment duration; and outputting the two or more encoded segments, wherein the two or more encoded segments have the same quality as each other. In some examples, the target bitrate corresponds to a user selected bitrate. In some examples, the chunk comprises two or more segments of the plurality of segments, one of the two or more segments having a lower complexity and another of the two or more segments having a higher complexity. In some examples, the internal chunk length is determined dynamically based on a length of the video input. In some examples, the internal chunk length is determined dynamically based on a quality requirement. In some examples, the multiple of the segment duration is at least two times the segment duration. In some examples, the segment duration comprises a user selected output segment duration.

A computer-implemented method for encoding a video input may include: receiving the video input and a user selected encoding parameter; in a first pass through the video input, extracting video characteristics from the video input as a whole; determining a file parameter for the video input based on the extracted video characteristics and a set of learned relationships mapping video characteristics to encoding parameters; in a second pass through the video input, performing a plurality of probe encodes in a substantially parallel manner on a plurality of chunks of the video input, an internal chunk length of at least one of the plurality of chunks being a multiple of a segment duration; segmenting the plurality of encoded chunks into a plurality of encoded segments, each of the plurality of encoded segments having the segment duration; and outputting the plurality of encoded segments. In some examples, the plurality of probe encodes is performed by a distributed video encoding system comprising a plurality of video encoders configured to encode a plurality of chunks in parallel. In some examples, the user selected encoding parameter comprises a target bitrate, each of the plurality of chunks being encoded with an average bitrate equal to the target bitrate. In some examples, the user selected encoding parameter comprises the segment duration. In some examples, the at least one of the plurality of chunks comprises two or more segments, one of the two or more segments having a lower complexity and another of the two or more segments having a higher complexity. In some examples, two or more of the plurality of probe encodes is performed at different time locations. In some examples, the set of learned relationships is determined using a machine learning module. In some examples, the plurality of probe encodes is performed by a distributed video encoding system comprising a plurality of video encoders configured to encode a plurality of chunks in parallel. In some examples, the distributed video encoding system is cloud-based.

### BRIEF DESCRIPTION OF THE DRAWINGS

Various non-limiting and non-exhaustive aspects and features of the present disclosure are described herein below with references to the drawings, wherein:

FIG. 1A is a simplified block diagram of an exemplary content encoding system for implementing video encoding with smart chunking according to embodiments of the invention.

FIG. 1B is a flow diagram illustrating an exemplary encoding process according to embodiments of the invention.

FIG. 1C is a flow diagram illustrating another exemplary encoding process according to embodiments of the invention.

FIG. 2A-C are simplified flow diagrams illustrating typical segment encoding with prior art video encoders.

FIG. 2D is a simplified flow diagram illustrating exemplary smart chunking for video encoding according to embodiments of the invention.

FIG. 3A is a graph illustrating quality degradation toward segment borders in prior art video encoding.

FIG. 3B is a graph illustrating improved quality resulting from smart chunking for video encoding according to embodiments of the invention.

FIG. 4A is a simplified block diagram illustrating quality distribution across output segments for prior art video encoding.

FIG. 4B is a simplified block diagram illustrating quality distribution across output segments for video encoding with smart chunking according to embodiments of the invention.

FIG. 5 is a flow diagram illustrating a method for smart chunking according to embodiments of the invention.

Like reference numbers and designations in the various drawings indicate like elements. Skilled artisans will appreciate that elements in the Figures are illustrated for simplicity and clarity, and have not necessarily been drawn to scale, for example, with the dimensions of some of the elements in the figures exaggerated relative to other elements to help to improve understanding of various embodiments. Common, well-understood elements that are useful or necessary in a commercially feasible embodiment are often not depicted in order to facilitate a less obstructed view of these various embodiments.

### DETAILED DESCRIPTION

The invention is directed to smart chunking for video encoding. Smart chunking for video encoding (e.g., VOD Encoder) increases the quality and turnaround times with split and stitch. The new functionality optimizes chunk lengths and bitrate distribution, delivering an improved visual quality throughout the whole asset that's visible to audiences and achieving this at an even faster pace than before.

Smart chunking is the next evolution of the split and stitch algorithm, which is when a video file is split into multiple parallel encoding jobs. The split and stitch algorithm accelerates encoding but can cause the quality to drop between segments due to bitrate “jumps,” which can be visible to the viewer. Smart chunking intelligently optimizes chunk lengths and bitrate distribution, ensuring smooth visual quality throughout the whole asset, achieving it at an even faster pace. To achieve this, the chunk duration is decoupled from an output segment duration (e.g., during one or more of the encoding methods described herein), which allows for variable chunk size depending on the type of codec and the complexity of encoding, providing the user with immediate and visible improvements. Specifically, user (e.g., customer, client) selected output segment duration may be decoupled from an internal chunk duration used by a video encoder. This allows for the selection of an optimal internal chunk duration based on input video and quality requirements.

Smart Chunking is a new innovation that ensures client devices can encode video files even more efficiently at speed and scale in the highest quality, with absolutely no tradeoffs. Smart Chunking will benefit all users with optimized split and stitch encoding, maximizing the viewing experience for audiences.

In one embodiment, an original input video file is encoded using a machine learning approach. In this embodiment, the encoder can make smart decisions about compression settings and visual parameters of each frame, speeding up processing and improving encoding efficiency. In one embodiment, the encoder performs a detailed video analysis and selection of encoding parameters that using a machine learning algorithm improves over time. The encoding algorithm is continuously optimized to determine an optimal set of encoding parameters for a set of video characteristics. In contrast to conventional approaches, according to embodiments, the encoding process is done using a multi-pass approach.

During a first pass, the entire video file is scanned to extract video property information that does not require in-depth analyses (e.g., motion predictions). The extracted data is then entered into an encoding engine, which uses artificial intelligence to produce optimized encoder settings. Those settings are tuned to content information such as a broad estimate of content complexity, which is easily obtainable and provides an initial level of optimization. According to one embodiment, using machine learning, the system improves progressively, as it obtains more and more information from encoding different input files and building connections between learned video characteristics and corresponding encoder settings that deliver high quality video outputs. In embodiments, the encoding process includes a feedback path that checks the output video against objective or subjective quality metrics. Based on the quality metrics, the results are entered into the artificial intelligence engine to learn the impact of the selected settings for the input video characteristics. As the AI's database of encoding settings and accompanying results keeps growing, so does the quality of the matching encoding parameters and file attributes.

According to embodiments, after breaking up the input video file into a set of time-based chunks, in a second pass, the encoding parameters for each chunk are set and distributed to encoding nodes for parallel processing. The video content chunks are distributed to different encoder processing instances. The goal for this distribution is to equally distribute workload among a cluster of servers to provide a high degree of parallel processing. These encoder instances probe-encode each chunk determine the level of complexity for the chunk and to derive chunk-specific encoding parameters. Following completion of the second pass, the results of both passes are then merged to obtain the necessary information for the encoder to achieve the best possible result.

According to embodiments, other passes of the chunks may further fine-tune the parameters based on quality metrics and feedback. Once the encoding parameters are selected, the last pass performs the actual encoding process. The encoding process, which may also be done by the encoder instances on the video chunks in a parallel fashion, uses the data gained from the analyses in the first two passes to make encoding decisions, eventually resulting in an optimum quality output video at maximum bandwidth efficiency.

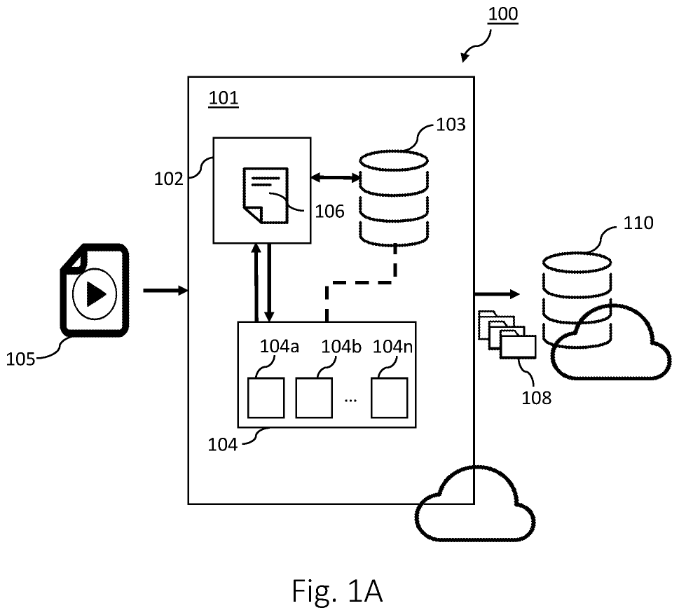

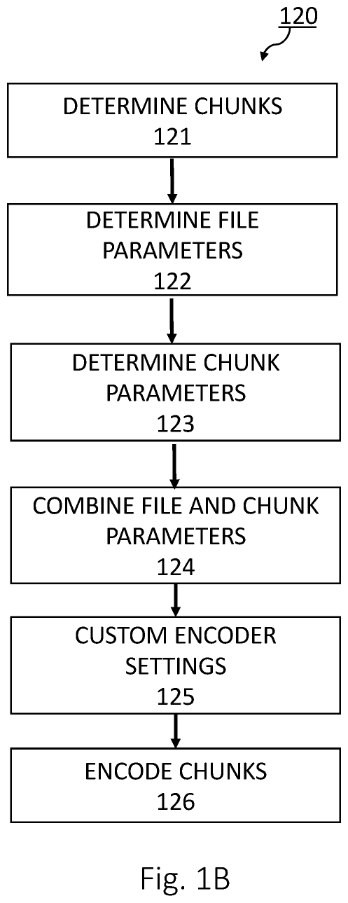

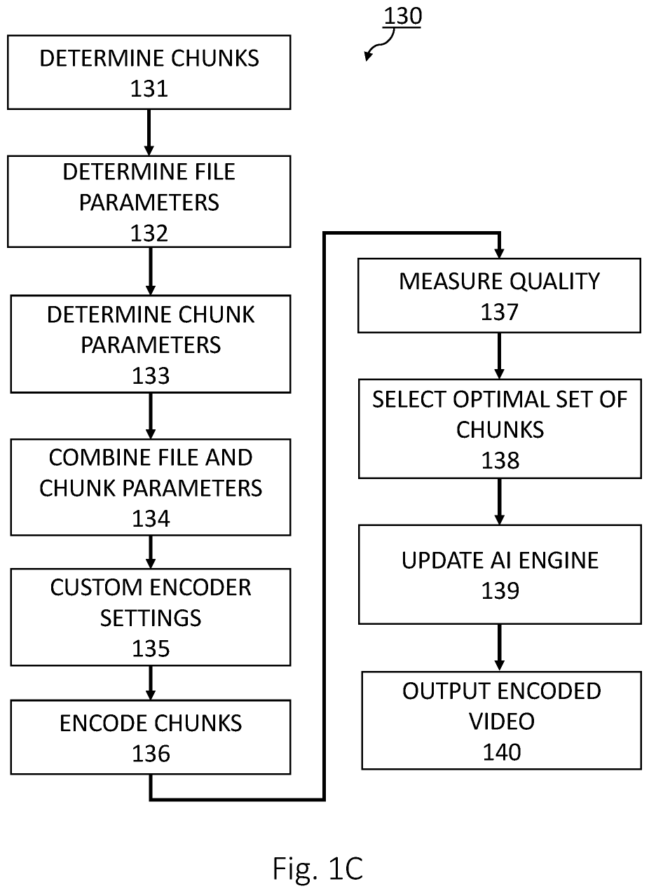

Now referring to FIG. 1, a content encoding system is illustrated according to embodiments of the invention. In one embodiment, the encoding system 100 is a cloud-based encoding system available via computer networks, such as the Internet, a virtual private network, or the like. The encoding system 100 and any of its components may be hosted by a third party or kept within the premises of an encoding enterprise, such as a publisher, video streaming service, or the like. The encoding system 100 may be a distributed system but may also be implemented in a single server system, multi-core server system, virtual server system, multi-blade system, data center, or the like. The encoding system 100 and its components may be implemented in hardware and software in any desired combination within the scope of the various embodiments described herein.

According to one embodiment, the encoding system 100 includes an encoder service 101. The encoder service 101 supports various input (HTTP, FTP, AWS-S3, GCS, Aspera, Akamai NetStorage, etc.) and output formats and multiple codecs (H264, H265, VP9, AV1, AAC, etc.) for VoD and live streaming. It also supports streaming protocols like MPEG-DASH and HLS and may be integrated with Digital Rights Managers (DRMs) like Widevine, Playready, Marlin, PrimeTime, Fairplay, and the like. According to embodiments, the encoder service 101 is a multi-cloud service capable of dynamically scaling with generation of processing nodes to support the workload. In one embodiment, for a particular encoding process, the encoder service 101 can generate an encoder coordinator node 102 supported by a machine learning module 103 and one or more encoder nodes 104.

According to embodiments, encoder nodes 104 can instantiate any number of encoder instances or submodules 104a, 104b, . . . , 104n, each capable of encoding an input video into an encoding format. The encoder node 104 performs the encodings, connecting inputs to outputs, applying codec configurations and filters on the input video files. The encoders can apply different and multiple muxings on streams like MPEG2-TS, fragmented MP4 and progressive MP4 and add DRM to the content and/or encrypted it as needed. Encoder node 104 can also extract and embed captions and subtitles, e.g., 608/708, WebVTT, SRT, etc.

For example, encoding submodule 104a may be an MPEG-DASH encoding submodule for encoding an input video 105 into a set of encoded media 108 according to the ISO/IEC MPEG standard for Dynamic Adaptive Streaming over HTTP (DASH). The encoding submodules 104b-104n may provide encoding of video for any number of formats, including without limitation Microsoft's Smooth Streaming, Adobe's HTTP Dynamic Streaming, and Apple Inc.'s HTTP Live Streaming. In addition, encoding submodules 104b-104n may use any type of codec for video encoding, including, for example, H.264/AVC, H.265/HEVC, VP8, VP9, AV1, and others. Any encoding standard or protocol may be supported by the encoder node 104 by providing a suitable encoding submodules with the software and/or hardware required to implement the desired encoding. In addition, in embodiments, encoder node 104 may be distributed in any number of servers in hardware, software, or a combination of the two, networked together and with the encoder coordinator node 102.

According to one aspect of embodiments of the invention, the encoder node 104 encodes an input video 105 at multiple bitrates with varying resolutions into a resulting encoded media 108. For example, in one embodiment, the encoded media 108 includes a set of fragmented MP4 files encoded according to the H.264 video encoding standard and a media presentation description (“MPD”) file according to the MPEG-DASH specification. In an alternative embodiment, the encoding node 104 encodes a single input video 105 into multiple sets of encoded media 108 according to multiple encoding formats, such as MPEG-DASH and HLS for example. Input video 105 may include digital video files or streaming content from a video source, such as a camera, or other content generation system. According to embodiments, the encoder node 104 processes a video file in time-based chunks corresponding to portions of the input video file 105. Encoding submodules 104a-n process the video chunks for a given input video file substantially in parallel, providing a faster encoding process than serially processing the video file 105. The encoder node 104 is capable of generating output encoded in any number of formats as supported by its encoding submodules 104a-n.

According to another aspect of various embodiments, the encoder node 104 encodes the input video based on a given encoder configuration 106. The encoder configuration 106 can be received into the encoding server 101, via files, command line parameters provided by a user, via API calls, HTML commands, or the like. According to one embodiment, the encoder configuration 106 may be generated or modified by the encoder coordinator node 102 and/or the machine learning module 103. The encoder configuration 106 includes parameters for controlling the content generation, including the variation of the segment sizes, bitrates, resolutions, encoding settings, URL, etc. For example, according to one embodiment, the input configuration 106 includes a set of target resolutions desired for encoding a particular input video 105. In one embodiment, the target resolutions are provided as the pixel width desired for each output video and the height is determined automatically by keeping the same aspect ratio as the source. For example, the following pixel-width resolutions may be provided 384, 512, 640, 768, 1024, 1280, 1600, 1920, 2560, 3840. In this embodiment, the encoded output 108 includes one or more sets of corresponding videos encoding in one or more encoding formats for each specified resolution, namely, 384, 512, 640, 768, 1024, 1280, 1600, 1920, 2560, and 3840. In one embodiment, a set of fragmented MP4 files for each resolution is included in the encoded output 108. According to yet another aspect of various embodiments, the encoder configuration 106 is customized for the input video 105 to provide an optimal bitrate for each target resolution.

According to embodiments, the machine learning module 103 learns relationships between characteristics of input video files 105 and corresponding encoder configuration settings 106. In one embodiment, the machine learning module 103, interacts with the coordinator node 102 to determine optimized encoding parameters for the video file 105 based on extracted video parameters and learned relationships between video parameters and encoding parameters through training and learning from prior encoding operations. In embodiments, the machine learning module 103 receives output from quality check functions measuring objective parameters of quality from the output of the encoder instance submodules 104a-n. This output provides feedback from learning the impact of encoder parameters 106 on quality given a set of input video 105 characteristics. According to embodiments, the machine learning module 103 stores the learned relationships between input video characteristics and encoder settings using artificial intelligence, for example, in a neural network.

According to another aspect of various embodiments, the encoded output 108 is then delivered to storage 110. The encoding service 101 can connect to cloud-based storage as an output location to write the output files. The specific location/path may be configured for each specific encoding according to embodiments. For example, in one embodiment, storage 110 includes a content delivery network (“CDN”) for making the encoded content 108 available via a network, such as the Internet. The delivery process may include a publication or release procedure, for example, allowing a publisher to check quality of the encoded content 108 before making available to the public. In another embodiment, the encoded output 108 may be delivered to storage 110 and be immediately available for streaming or download, for example, via a website.

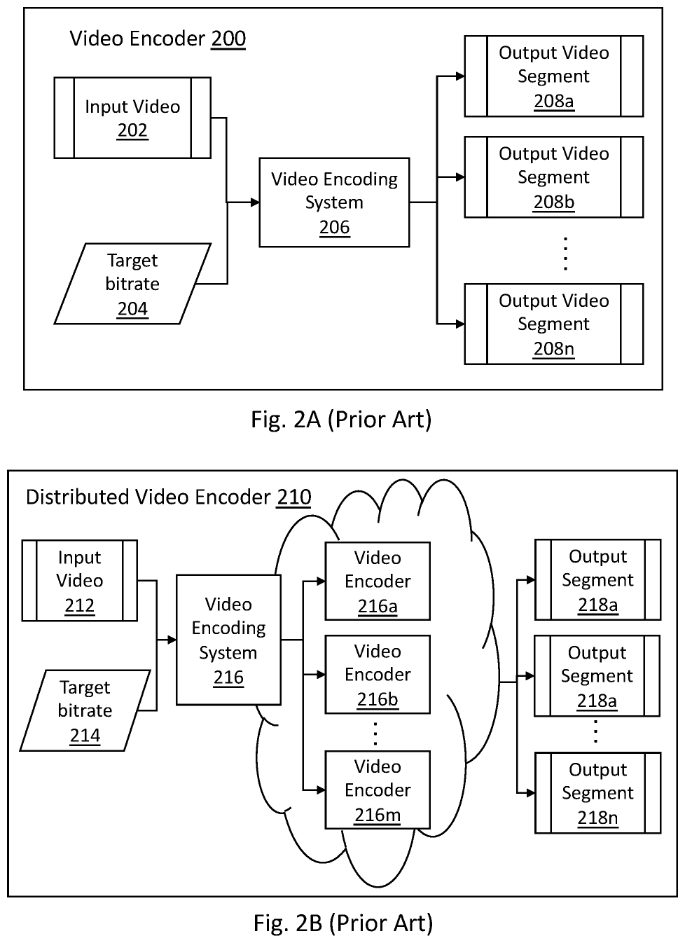

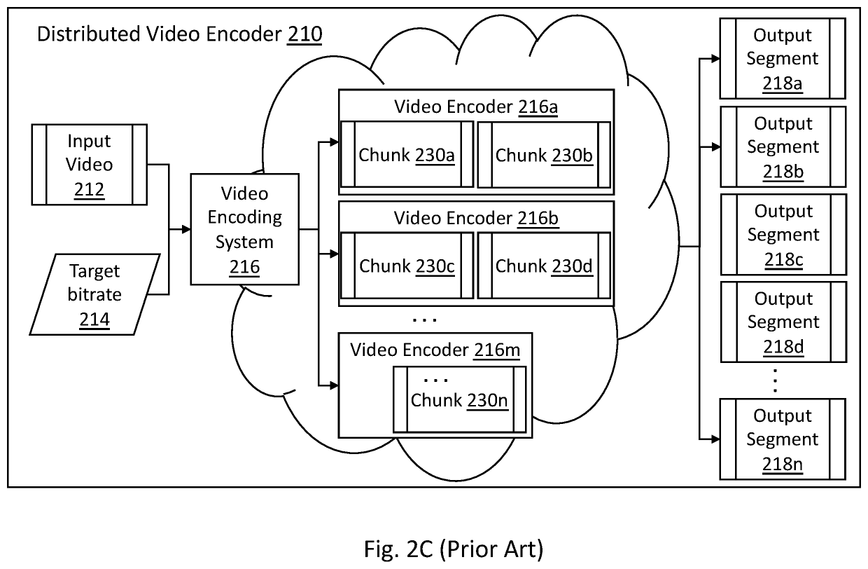

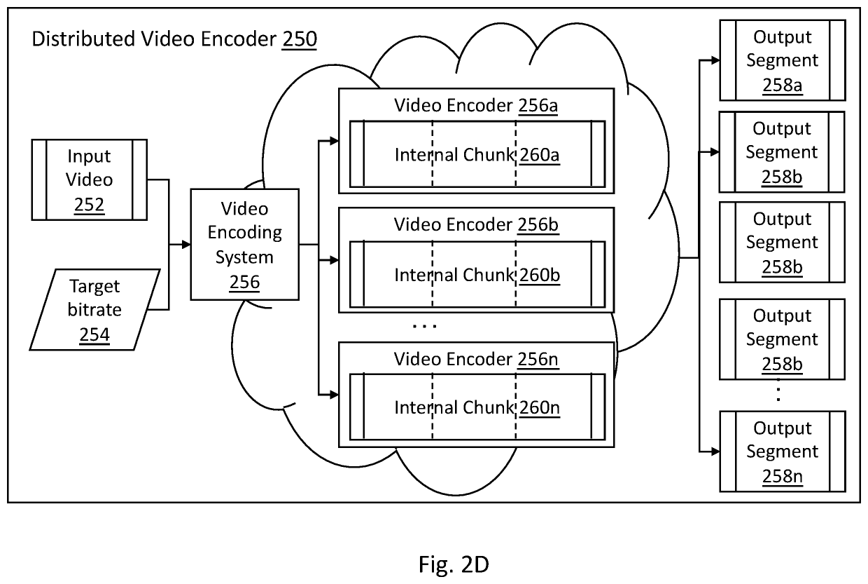

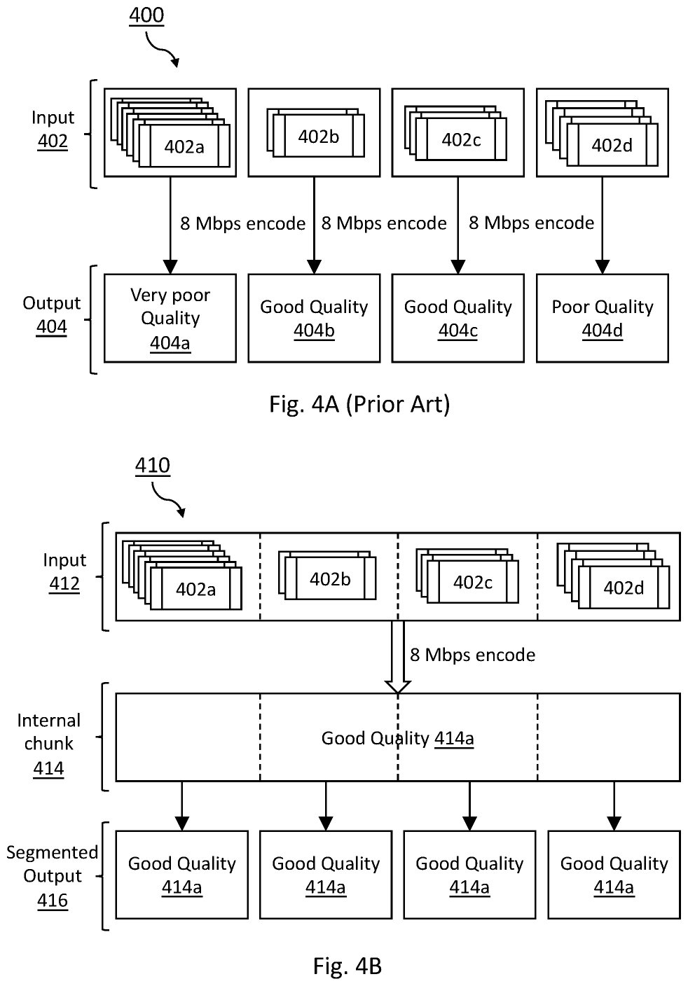

FIG. 1B is a simplified block diagram illustrating an exemplary encoding process according to embodiments of the invention. In FIG. 1B, an encoding process is provided according to various embodiments. According to one embodiment, the encoding process 120 determines a set of video content chunks at step 121. The process also performs a first pass through the input video file 105 to analyze its characteristics and determine a set of file parameters at step 122, the set of file parameters to be used in an encoding process. In a second pass, the video content chunks are processed in a substantially parallel manner by, for example, encoder instance nodes 104a-n, performing probe encodes of the chunk at different time locations to analyze the complexity and extract other characteristics or properties of the video in the chunk and determine encoder parameters applicable to each chunk at step 123. The file parameters may then be combined with the chunk parameters at step 124, including applying overall limits, transition values for encoding rates, filters, and the like, to arrive at a set of customer encoder settings for each chunk to be encoded at step 125. The custom settings may then distributed to the encoder instances for parallel encoding the chunks at step 126, for example, to produce an encoded video output (e.g., output 108 in FIG. 1, output video segments 208a-208n in FIG. 2A, output segments 218a-218n in FIG. 2B, output segments 218a-218n in FIG. 2C, output segments 258a-258n in FIG. 2D, output 404 in FIG. 4A, segmented output 416 in FIG. 4B, and the like).

According to embodiments, each video chunk corresponds to a time slice of the overall input video file 105. The chunk determination step 121 may be performed at any time before determining the chunk parameters 123. In some embodiments, the input video file 105 is segmented or divided up into time-based clips or chunks that may overlap in time. For example, if the input video file 105 is encoded according to an MPEG standard, the location of non-referential frames, e.g., iFrames, may impose limitations regarding where each chunk begins and/or ends. The described approach works on chunks of any size. Smaller chunk sizes may have some benefits as they allow better parallelization of the processing, but they also require more fine-granular put settings per chunk. The optimal chunk size depends on desired size of files for subsequent processing and on the type of content. For example, fast moving content, like action movies, may benefit from smaller chunk sizes while content with lower action scenes, without much motion and possibly higher compression, may benefit from longer chunks. In some examples, the target chunk size is variable and may be a user configurable setting. In other examples, the chunk size may be decoupled from a user segment duration selection. In some examples, chunk determination step 121 may comprise smart chunking, as described herein and shown in FIGS. 2D, 3B, 4B, and 5.

According to embodiments, once a target chunk size is set, the pre-encoding process cuts the input video file 105 into chunks of approximately the set target chunk size. As noted above, in one embodiment, once the target chunk size is reached, the video file is not cut until a non-referential frame is reached. In some embodiments, the next chunk starts at the target chunk size from the previous chunk even if the actual cut location exceeds the target. In these embodiments, the video corresponding to the time in excess of the target chunk size is removed and discarded before finalizing an output (e.g., output 108 in FIG. 1, output video segments 208a-208n in FIG. 2A, output segments 218a-218n in FIG. 2B, output segments 218a-218n in FIG. 2C, output segments 258a-258n in FIG. 2D, output 404 in FIG. 4A, segmented output 416 in FIG. 4B, and the like). In these embodiments, ultimately all the chunks are of the same size. In alternative embodiments, the next chunk begins after the actual cut location, resulting in chunks of different sizes.

Referring back to FIG. 1B, in embodiments, a first pass through the input video file 105 determines file parameters applicable to the video content as a whole at step 122. In an embodiment, a first pass determines the context in which the actual encoding of each chunk will be performed. The file parameters provide this context in terms of the structure of the file and the changes between scenes or portions of the file. For example, in one embodiment, the file-level context provides a relative complexity of each chunk compared to other chunks. In embodiments, quality factors applicable to the overall video content are determined. For example, the noisiness of the video content, whether any filters should be applied, such as sharpening filters, deinterlace, denoise, unsharp, audio volume, or the like. With this file-level context, the overall appearance of the encoded output can be maintained. For example, context is used to determine a range of bitrates that each individual chunk should be encoded within. It also allows for smooth transitions for filters and rates between chunks.

In embodiments, the input video content inspection during this first pass provides a set of characteristics for the input video file 105 that is analyzed by a machine learning module to determine appropriate encoder settings (e.g., parameters) for the file at step 122. For example, in one embodiment, a neural network may be used to map a set of input video content characteristics to a set of encoder settings. The input video content characteristics can include any number of quality factors, such as noisiness or peak signal-to-noise ratio (“PSNR”), video multimethod assessment fusion (“VMAF”) parameters, structural similarity (SSIM) index, as well as other video features, such as motion-estimation parameters, scene-change detection parameters, audio compression, number of channels, or the like. In some embodiments, the input video content characteristics can include subjective quality factors, for example obtained from user feedback, reviews, studies, or the like. In embodiments, the input video characteristics are analyzed with machine learning to provide a set of encoder settings for the video file. The machine learning algorithms can be trained with any source of quality factors or a combination of them. As further described below, after an initial set of default encoder settings, the machine learning algorithm is provided feedback regarding the quality of the resulting video output. The machine learning module applies the quality results to modify the encoder settings, learning from the effects on the resulting quality.

In different embodiments, the video file parameters that result from the first pass can include quantizer step settings, target bit rates, including average rate and local maxima and minima for any chunk, target file size, motion compensation settings, maximum and minimum keyframe interval, rate-distortion optimization, psycho-visual optimization, adaptive quantization optimization, other filters to be applied, and the like, that would apply to the entire file.

According to embodiments, the process also determines chunk parameters that are specific to each video chunk at step 123. This step may be done simultaneously with the file parameters determination or sequentially, and preferably performed substantially at the same time for all or a subset of the determined video chunks. This approach beneficially speeds up the encoding process for a given input video file. To determine the chunk parameters at step 123, each chunk may be probe encoded to analyze the content. Probe encoding is a fast an efficient way to determine the bitrates that will be required to encode a given chunk at a given target resolution. For example, chunks with action content with rapidly changing, fast-moving, scenes will result in a higher average bitrate than a cartoon or a slower pace film with long segments from the same camera angle of a mostly stationary scene.

According to one embodiment, in a second pass, a chunk may be input for analysis and the probe encoding of the chunk may involve determining a set of time codes in the input video chunk. In one embodiment, the time codes are determined based on configurable parameters, for example via input files, user input, or the like. In an alternative embodiment, the time codes are based on preconfigured parameters. For example, a number of time codes is one such parameter which may be preconfigured or may be part of the input configuration for the encoding process. In one embodiment, the number of time codes may be set based on the length of the chunks (e.g., 2-3 time codes per chunk). The number of time codes may be fully configurable in different embodiments. As the number of time codes increases, the performance of the probe encoding will decrease, all other parameters being equal, therefore there is a tradeoff between increasing the number of time codes and the time it will take to perform the probe encoding process.

According to one embodiment, once the time codes are determined, the input video chunk may be accessed at the location in the video input specified by the first time code. The video may then be encoded for the sample time specified (e.g., 2 seconds, 10 seconds, 30 seconds, 1 minute, or the like). The longer the sample time, the longer it takes to perform the probe encode. In one embodiment, the probe encode process is done serially on each sample location and its duration is the sum of the sample encoding for each sample locations. In another embodiment, the probe encode process is done in parallel with a plurality of encoding nodes 104a-n. In this embodiment, the duration of the probe encode can be reduced to the encoding time for the longest encode from the encodings of all the samples. The probe encode delivers an average bitrate. The process then checks to see if the current time code is the last time code of the chunk. In one embodiment, if the probe encodes are done serially, while the last time code is not reached, the time codes are increased and set to the next time code. Then the process may repeat to encode sample times for each time code in the chunk. In some embodiments, only one time code per chunk may be used.

The mean of the average bitrates for the encodings at the current resolution may be computed and recorded. According to embodiments, the probe encoding may be repeated for multiple target resolutions. If so, once the last target resolution is reached, the recorded mean bitrates for each resolution can be used to provide a custom bitrate table for each chunk. A process for generating custom bitrate tables is described in co-pending U.S. patent application Ser. No. 16/167,464, titled Video Encoding Based on Customized Bitrate Table, filed on Oct. 22, 2018, by Bitmovin, Inc., which is incorporated herein by reference in its entirety. The chunk may also be analyzed to derive other video characteristics or properties of the chunk, such as complexity, motion analysis factors, special compression, and the like.

Referring back to FIG. 1B, according to one embodiment, the chunk parameter determination at step 123 may include performing a deep analysis of the chunk, for example, based on a probe encoded process, and may be otherwise similar to the first pass of a conventional encoder. As the encoder node runs through the video chunk, a statistics file (“.stats file”) for the chunk may be written saving the statistics for each frame in the chunk. According to one embodiment, during this process, the combining of the file and chunk encoder parameters may begin at this step, where file parameter settings from the first pass are applied during this pass to generate the chunk statistics file, with information about quantizer and encoding rate for each frame to reach target bitrate.

Through the combining of the chunk encoder parameters and file encoder parameters, for example in the .stats file, a set of custom encoder settings for each chunk may be generated at step 125. The custom encoder settings may take into account file-wide features, such as overall quality, target bitrate, filters, etc. applied to each chunk to maintain the overall quality and look of the output, provide smooth transitions between contiguous chunks, and avoid sudden changes. For example, if the analysis of a chunk determined a maximum encoding bitrate that exceeded the maximum encoding bitrate determined for the file, the chunk bitrate would be reduced accordingly. Similarly, if two contiguous chunks resulted in disparate encoding bitrates, the file level parameters would provide for a smooth transition from one bitrate in the first chunk to the second bitrate in the next chunk. Similarly, filters required for one chunk may also cause contiguous chunks to begin the application of the filter, gradually increasing its effect to the desired filtering at the required location in the chunk. Through the combining of file and chunk parameters at step 124, the custom encoder settings at step 125 may define optimized encoding settings and pre- and post-processing steps on a per-chunk basis.

These custom encoder settings, including the chunk .stats files, may be applied in parallel during a third pass to encode the chunks at step 126 thereby producing a final encoded output (e.g., output 108 in FIG. 1, output video segments 208a-208n in FIG. 2A, output segments 218a-218n in FIG. 2B, output segments 218a-218n in FIG. 2C, output segments 258a-258n in FIG. 2D, output 404 in FIG. 4A, segmented output 416 in FIG. 4B, and the like).

FIG. 1C is a flow diagram illustrating another exemplary encoding process according to embodiments of the invention. The process 130 determines a set of video content chunks 131. The process also performs a first pass through the input video file 105 to analyze its characteristics and determine 132 sets of file parameters to be used in the encoding process. In a second pass, the video content chunks are processed in a substantially parallel manner by, for example, encoder instance nodes 104a-n, performing probe encodes of the chunk at different time locations to analyze the complexity and extract other properties of the video in the chunk and determine encoder parameters applicable to each chunk at step 133. The file parameters are then combined with the chunk parameters at step 134, applying overall limits, transition values for encoding rates, filters, and the like, to arrive at a set of custom encoder settings for each chunk to be encoded at step 135. The custom settings are then distributed to the encoder instances for parallel encoding the chunks at step 136 to produce an encoded video output (e.g., output 108 in FIG. 1, output video segments 208a-208n in FIG. 2A, output segments 218a-218n in FIG. 2B, output segments 218a-218n in FIG. 2C, output segments 258a-258n in FIG. 2D, output 404 in FIG. 4A, segmented output 416 in FIG. 4B, and the like).

According to embodiments, the process 130 may then measure the quality of the video in the resulting encoded output at step 137. The process 130 may be repeated multiple times with any number of passes, with steps 132-137 applied to the same chunks with varying parameters and varying custom encoder settings. Based on the quality measures, the optimal set of chunks are selected for output at step 138 and the artificial intelligence module updated at step 139 with the feedback-based learning provided by this process, increasing the relevance of parameters that contribute to higher quality output and decreasing the relevance of parameters that decrease the quality. For example, a neural network may adjust its predictions based on the quality metrics. An encoded video (e.g., output 108 in FIG. 1, output video segments 208a-208n in FIG. 2A, output segments 218a-218n in FIG. 2B, output segments 218a-218n in FIG. 2C, output segments 258a-258n in FIG. 2D, output 404 in FIG. 4A, segmented output 416 in FIG. 4B, and the like) may be output at step 140. This process 130 may be used for training the machine learning module, developing relationships between input video characteristics and parameters based on quality metrics of the resulting encoded video.

FIG. 2D is a simplified flow diagram illustrating exemplary smart chunking for video encoding according to embodiments of the invention. Distributed video encoder flow 250 illustrates an exemplary flow for implementing smart chunking in an encoding process (e.g., process 120, process 130, and the like). Distributed video encoder flow 250 may comprise a video encoding system 256 configured to receive input video 252 and target bitrate 254. Video encoding system 256 may be a distributed system comprising a plurality of video encoders 256a-256n configured to encode input video 252 using internal chunk lengths 260a-260x, which are decoupled from segment durations for output segments 258a-258n. In contrast to encoders 200 and 210 in FIGS. 2A-2C wherein chunks 230a-230n are the same duration as output segments 218a-218n, internal chunk lengths 260a-260n may be a multiple of the durations of output segments 258a-258n. For example, each of internal chunk lengths 260a-260n may be double, 3 times, 4 times, or other multiple of, a duration or length of any one of output segments 258a-258n. This will allow the plurality of video encoders 256a-256n to better determine how to spend available bitrate and decrease the impact at segment borders (e.g., fewer segment borders). In an example, an internal chunk length that is 4 times an output segment length will result in 4 times less affected segment borders. In some examples, one or both of target bitrate 254 and segment duration of output segments 258a-258n may be selected by a user.

In some examples, video encoders 256a-256n may be distributed across one or more physical servers, virtual servers, cloud servers, and/or other servers. For example, video encoders 256a-256n may be the same or similar to encoder instances or submodules 104a-104n. In some examples, the plurality of video encoders 256a-256n may be configured to encode two or more chunks (e.g., internal chunks 260a-260n) from input video 252 in parallel, wherein the two or more chunks may be encoded by separate video encoders during overlapping, although not necessarily at the exact same, times.

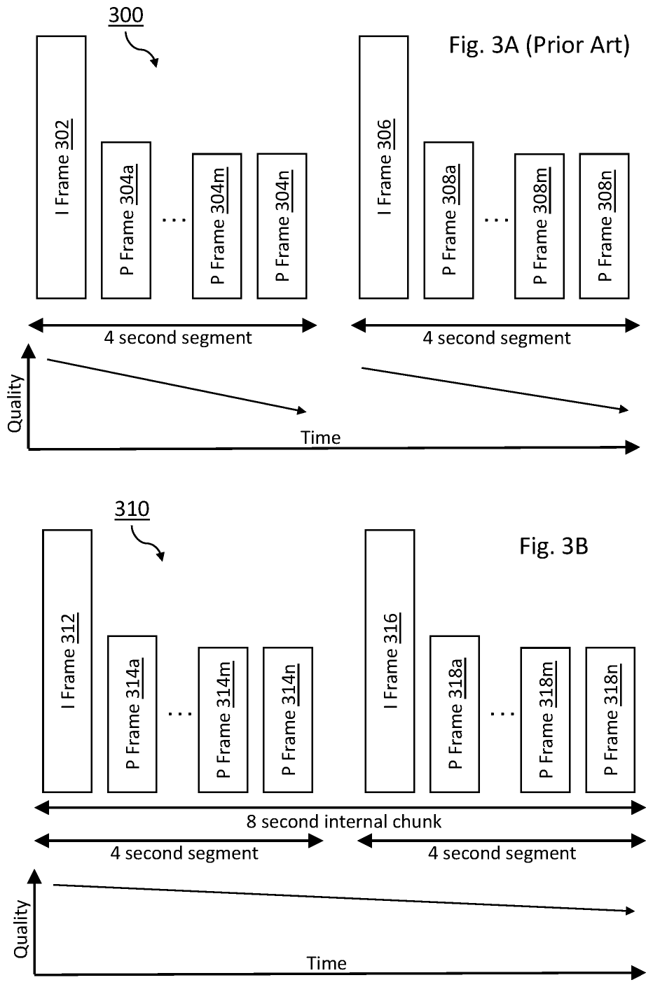

FIG. 3A is a graph illustrating quality degradation toward segment borders in prior art video encoding. As you can see in graph 300, when the segments are 4 seconds in length, the quality drops with each 4-second segment, for example, from iFrame 302 through pFrames 304a-304n in a first 4-second segment and from I frame 306 through P frames 308a-308n in a second 4-second segment. FIG. 3B is a graph illustrating improved quality resulting from smart chunking for video encoding according to embodiments of the invention. In contrast to graph 300 (in FIG. 3A), graph 310 shows an 8-second internal chunk for encoding that includes iFrames 312 and 316, along with pFrames 314a-314n and 318a-318n. This decreases the impact at segment borders by approximately 2× because there are 2× fewer segment borders in the internal chunk. In other examples, the internal chunk may be set to 3×, 4×, or another multiple of, the segment duration, and a proportional reduction in segment borders, and thereby segment border degradation impact, may be achieved.

Furthermore, internal chunks with longer duration will have less chance of having only low or only high complexity video scenes, therefore the overall quality distribution will be better. FIG. 4B is a simplified block diagram illustrating quality distribution across output segments for video encoding with smart chunking according to embodiments of the invention. As shown in diagram 410, when the same segments from diagram 400 in FIG. 4A (i.e., very high complexity segment 402a, very low complexity segment 402b, low complexity segment 402c, and medium complexity segment 402d) are encoded in a longer internal chunk 414 with an average target bitrate (e.g., 8 Mbps), the resulting quality across the internal chunk 414 may be a good quality 414a because the encoder can adapt to the various complexities across segments 402a-402d (e.g., encoding at varying bitrates to account for varying complexities) and still match the overall (e.g., average) bitrate for internal chunk 414 to the target bitrate. Therefore the resulting segmented output 416 can be provided with good quality 414a, rather than the unstable quality of output 404 in FIG. 4A.

In some examples, internal chunk duration (e.g., internal chunks 260a-260n in FIG. 2D, internal chunk 414 in FIG. 4B) may be dynamically selected based on length of video input and quality requirements. In some examples, a longer internal chunk duration may be selected for a longer video input with a high quality requirement, whereas a shorter internal chunk duration may be selected for a shorter video input with lower quality requirements. A shorter video input with a high quality requirement still may benefit from a longer internal chunk duration. For example, a longer internal chunk may be selected for a 2-hour video input with a high quality requirement (e.g., high target bitrate with a big number of high renditions). The longer internal chunks will result in fewer quality issues at segment borders, improved quality distribution by enabling the encoder to distribute the bitrate across the longer internal chunk for better quality output segments at a given average target bitrate, and reduce overhead associated with encoding each internal chunk since there will be fewer internal chunks. In another example, the same system may choose a short internal chunk duration wherein the video input is short and there is a low quality requirement.

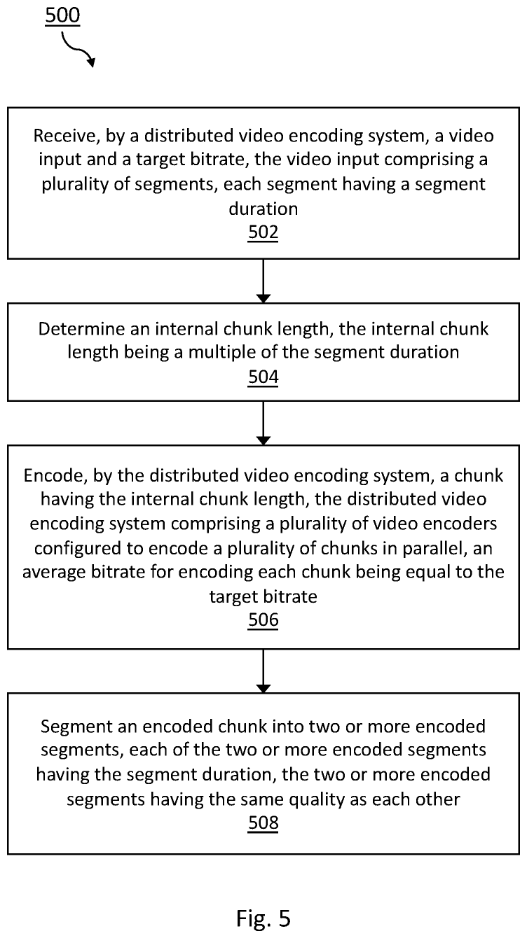

FIG. 5 is a flow diagram illustrating a method for smart chunking according to embodiments of the invention. Process 500 may begin with receiving, by a distributed video encoding system, a video input and a target bitrate at step 502, the video input comprising a plurality of segments, each segment having a segment duration. An internal chunk length may be determined at step 504, the internal chunk length being a multiple of the segment duration. The distributed video encoding system may encode the video input in chunks at step 506. For example, one or more chunks having the internal chunk length may be encoded in this step. In some examples, the distributed video encoding system may comprise a plurality of video encoders configured to encode a plurality of the chunks in parallel, as described herein. In some examples, an average bitrate for encoding each chunk may be equal to the target bitrate, as described herein. An encoded chunk may be segmented into two or more encoded segments at step 508, each of the two or more encoded segments having the segment duration, the two or more encoded segments having the same quality as each other. In some examples, an encoded video output (e.g., output 108 in FIG. 1, output video segments 208a-208n in FIG. 2A, output segments 218a-218n in FIG. 2B, output segments 218a-218n in FIG. 2C, output segments 258a-258n in FIG. 2D, output 404 in FIG. 4A, segmented output 416 in FIG. 4B, and the like) comprising the two or more encoded segments may be provided, for example, to a client device (e.g., media player) for streaming.

While specific examples have been provided above, it is understood that the present invention can be applied with a wide variety of inputs, thresholds, ranges, and other factors, depending on the application. For example, the time frames and ranges provided above are illustrative, but one of ordinary skill in the art would understand that these time frames and ranges may be varied or even be dynamic and variable, depending on the implementation.

As those skilled in the art will understand, a number of variations may be made in the disclosed embodiments, all without departing from the scope of the invention, which is defined solely by the appended claims. It should be noted that although the features and elements are described in particular combinations, each feature or element can be used alone without other features and elements or in various combinations with or without other features and elements. The methods or flow charts provided may be implemented in a computer program, software, or firmware tangibly embodied in a computer-readable storage medium for execution by a general-purpose computer or processor.

Examples of computer-readable storage mediums include a read only memory (ROM), random-access memory (RAM), a register, cache memory, semiconductor memory devices, magnetic media such as internal hard disks and removable disks, magneto-optical media, and optical media such as CD-ROM disks.

Suitable processors include, by way of example, a general-purpose processor, a special purpose processor, a conventional processor, a digital signal processor (DSP), a plurality of microprocessors, one or more microprocessors in association with a DSP core, a controller, a microcontroller. Application Specific Integrated Circuits (ASICs), Field Programmable Gate Arrays (FPGAs) circuits, any other type of integrated circuit (IC), a state machine, or any combination of thereof.

What is claimed is:

1. A method for video encoding with smart chunking, comprising:
receiving, by a distributed video encoding system, a video input and a target bitrate, the video input comprising a plurality of segments, each segment having a segment duration;
determining an internal chunk length, the internal chunk length being a multiple of the segment duration;
encoding, by the distributed video encoding system, a chunk having the internal chunk length, the distributed video encoding system comprising a plurality of video encoders configured to encode a plurality of chunks in parallel, an average bitrate for encoding the chunk being equal to the target bitrate;
segmenting an encoded chunk into two or more encoded segments, each of the two or more encoded segments having the segment duration; and
outputting the two or more encoded segments,
wherein the two or more encoded segments have the same quality as each other.

2. The method of claim 1, wherein the target bitrate corresponds to a user selected bitrate.

3. The method of claim 1, wherein the chunk comprises two or more segments of the plurality of segments, one of the two or more segments having a lower complexity and another of the two or more segments having a higher complexity.

4. The method of claim 1, wherein the internal chunk length is determined dynamically based on a length of the video input.

5. The method of claim 1, wherein the internal chunk length is determined dynamically based on a quality requirement.

6. The method of claim 1, wherein the multiple of the segment duration is at least two times the segment duration.

7. The method of claim 1, wherein the segment duration comprises a user selected output segment duration.

8. A computer-implemented method for encoding a video input, the method comprising:
receiving the video input and a user selected encoding parameter;
in a first pass through the video input, extracting video characteristics from the video input as a whole;
determining a file parameter for the video input based on the extracted video characteristics and a set of learned relationships mapping video characteristics to encoding parameters;
in a second pass through the video input, performing a plurality of probe encodes in a substantially parallel manner on a plurality of chunks of the video input, an internal chunk length of at least one of the plurality of chunks being a multiple of a segment duration;
segmenting the plurality of encoded chunks into a plurality of encoded segments, each of the plurality of encoded segments having the segment duration; and
outputting the plurality of encoded segments.

9. The method of claim 8, wherein the plurality of probe encodes is performed by a distributed video encoding system comprising a plurality of video encoders configured to encode a plurality of chunks in parallel.

10. The method of claim 8, wherein the user selected encoding parameter comprises a target bitrate, each of the plurality of chunks being encoded with an average bitrate equal to the target bitrate.

11. The method of claim 8, wherein the user selected encoding parameter comprises the segment duration.

12. The method of claim 8, wherein the at least one of the plurality of chunks comprises two or more segments, one of the two or more segments having a lower complexity and another of the two or more segments having a higher complexity.

13. The method of claim 8, wherein two or more of the plurality of probe encodes is performed at different time locations.

14. The method of claim 8, wherein the set of learned relationships is determined using a machine learning module.

15. The method of claim 8, wherein the plurality of probe encodes is performed by a distributed video encoding system comprising a plurality of video encoders configured to encode a plurality of chunks in parallel.

16. The method of claim 15, wherein the distributed video encoding system is cloud-based.
